(19) United States
(12) Patent Application Publication
(10) Pub. No.: US 2005/0021685 A1
(43) Pub. Date: Jan. 27, 2005

(54) Method for providing services in communications systems, communications system and computer programme

(76) Inventors: Maria Froschl, Ottobrunn (DE); Klaus Kienzle, Sauerlach (DE)

Correspondence Address: Siemens Corporation;Intellectual Property Department, 170 Wood Avenue South, Iselin, NJ, 08830, US

(21) Appl. No.: 10/491,076

(22) PCT Filed: Sep. 27, 2002
(86) PCT No.: PCT/DE02/03673

(30) Foreign Application Priority Data
Sep. 28, 2001 (DE) 101 48 011.3

(51) Int. Cl. G06F 15/177

(52) U.S. Cl. 709/220

(57) ABSTRACT

The invention relates to the provision of services in communications systems comprising at least a first and a second sub-network, in which different switching technologies are used. According to the invention, information, which is relevant to configuration and describes the functions of network elements is saved globally for the sub-networks to a network element database. When a service is established, modified and/or cancelled, network elements are configured by a network operating system, which accesses information that has been saved to the network element database.

### CROSS REFERENCE TO RELATED APPLICATIONS

This application is the US National Stage of International Application No. PCT/DE02/03673, filed Sep. 27, 2002 and claims the benefit thereof. The International Application claims the benefits of German application No. 10148011.3 DE filed Sep. 28, 2001, both of the applications are incorporated by reference herein in their entirety.

### FIELD OF INVENTION

Modern telecommunication services are frequently based on different technologies, and the provision of these services necessitates a configuration of resources in networks of different technologies.

### BACKGROUND OF INVENTION

To provide a broadband Internet access based on ADSL technology (Asynchronous Digital Subscriber Line), for example, a connection is set up via an ATM access network (Asynchronous Transfer Mode). In addition an access router is configured in the IP network (Internet Protocol) for an ADSL connection.

To provide an ISDN customer connection via SDSL technology (Single Line Digital Subscriber Line), a connection is likewise set up via an ATM access network. In addition, a transition into a fixed line telephone network and an ISDN customer in the fixed line telephone network are set up. Other examples of services that are provided in heterogeneous network environments are VPN (Virtual Private Network) or LAN-LAN couplings (Local Area Network) via xDSL technology.

In the above mentioned cases, the network elements of different technologies must be configured by a service provider. These network elements include DSLAMs (Digital Subscriber Line Access Multiplexer), ATM switching nodes in the ATM access network, IP routers in the network of an Internet service provider (ISP) and telephone switching systems in the fixed line telephone network. For different sub-networks, there are associated network operating systems (Network Management System) each with different databases containing information on the network elements assigned to the respective sub-network. The network resources formed by the network elements are configured via the network operating systems.

Formerly, network elements that are to be configured in the course of providing a service, are controlled by means of the sub-network and using information on these network elements in sub-network and switching technology specific databases. Where there are numerous transitions between sub-networks, in which different switching technologies are used, for example, connection, package or cell oriented switching, manual synchronization and administration is frequently necessary.

### SUMMARY OF INVENTION

The object of this invention is to determine a method, a communication system and a computer program for the standardized provision of services in heterogeneous network environments, in which different switching technologies are used.

This object is solved according to invention by a method with the characteristics stated in claim 1, a communication system with the characteristics stated in claim 3 and a computer program with the characteristics stated in claim 4. Advantageous developments of the method according to the invention are given in the dependent claims.

An essential aspect of this invention lies in an amalgamation of information, which is relevant to the configuration and describes the functions of the network elements, globally for the sub-networks in a network element database. Thus, in the event of a service being established, altered and/or cancelled, it is possible to provide system—homogenous configuration of network elements by a network operating system, which accesses information that has been saved to the network element database.

### BRIEF DESCRIPTION OF THE DRAWINGS

Through an embodiment, this invention is explained in greater detail below, using the drawing. It shows

FIG. 1 a diagrammatic view of objects of a data model for a network element database,

FIG. 2 a diagrammatic view of a provision of speech and data services using DSL technology,

FIG. 3 a further diagrammatic view of a provision of services using DSL technology,

FIG. 4 a diagrammatic view of a data technology modeling of network levels.

### DETAILED DESCRIPTION OF INVENTION

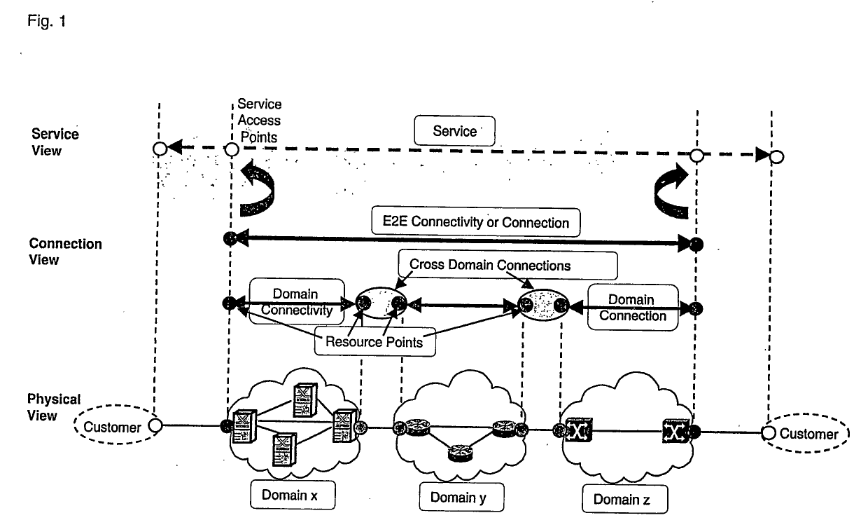

According to the diagrammatic view represented in FIG. 1, a data model independent of switching technologies used in sub-networks is used for a communication system. This data model allows a rule-based service provision on the basis of a single network element database with a total system view. In particular, it is possible to describe sub-networks with connection; package and cell oriented switching technologies in a data model. Here information, which is relevant to configuration and describes the functions of network elements, and which is saved in sub-network individual databases, is reduced and generalized to such an extent that an administration is possible in essentially all services. Existing databases are, for example, not replicated or replaced, but the information contained in them is mapped on a generic model.

Based on the data model specified for the network element database, in principle for each network scenario, rules are defined for the provision of services offered. The data model should be made in such a way as to map as near as possible all network technologies sufficiently accurately to enable the provision of the services between two ends of a communication link. To this end, the model maps the network topology with all network transitions. In addition, existing connections including resources engaged by this are mapped. In the data model, all network hierarchies and hence the network level structure are known, for example, ATM over SDH (Synchronous Digital Hierarchy), IP over SDH, Voice over IP. The data model specified for the network element database contains the following objects:
Network—represents the whole network, which can consist of one or more sub-networks;
Sub-network (Domain)—maps the technology-specific Sub-Networks and contains different types of end point network elements;
End point network element (Gate Network Element)—represents the network elements that provide resources for end points of connections; only those network elements are modeled which are at the edge of a sub-network, i.e. those network elements which provide access points for sub-network internal connections or sub-network connections;
Access point (Resource Point)—is contained in objects of the type “end point network element” (Gate Network Element) and models both connection resources, for example, the “containers” for connection end points or, as the case may be, physical connections, as well as connection end points themselves;
Sub-network internal connection (Domain Connection)—models connections within a sub-network;
Sub-network connection (Cross Domain Connection)—models network transitions between sub-networks;
End-to-end connection—represents connections that are made up of a concatenation of sub-network connections and sub-network connection;
Connectivity—models connection options between two access points; as opposed to a connection, at least one segment of an end-to-end path is based on connectionless transmission; an end-to-end connectivity can depend on a connection that implements the communication on a section of an end-to-end path;
Profile—specifies parameters of sub-network internal connections, end-to-end connections and connectivity.

Each end-to-end service exists between two access points (Resource Points), which are known in the data model, and a service profile. In order to provide a service, only this information, the two end points and the service profile are required, and a rule by which the service is to be constructed. Now each service is assigned an underlying network scenario, on the basis of which it is to be implemented in the telecommunication network.

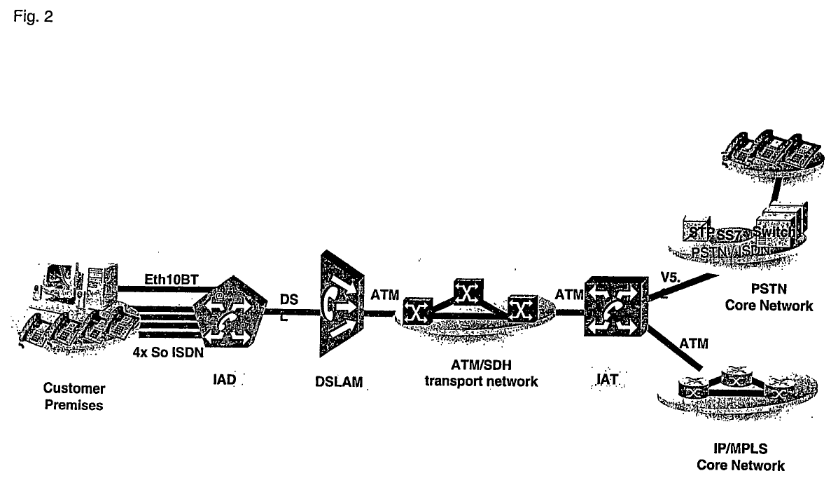

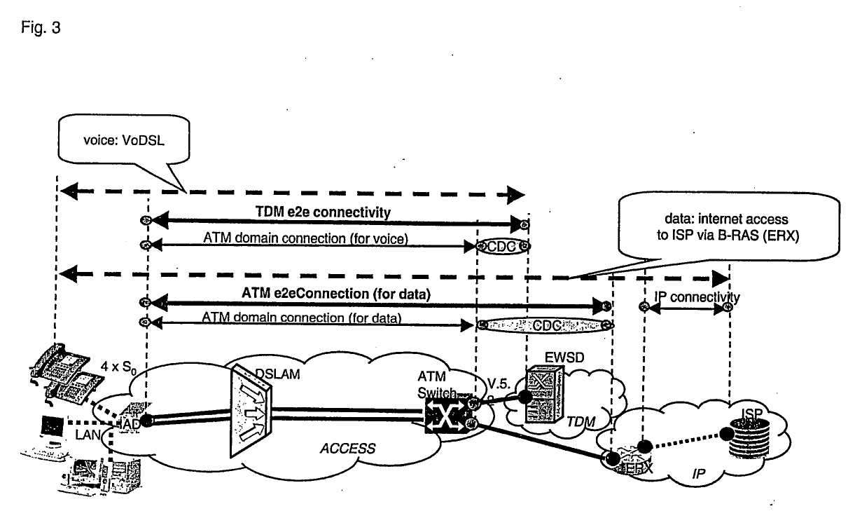

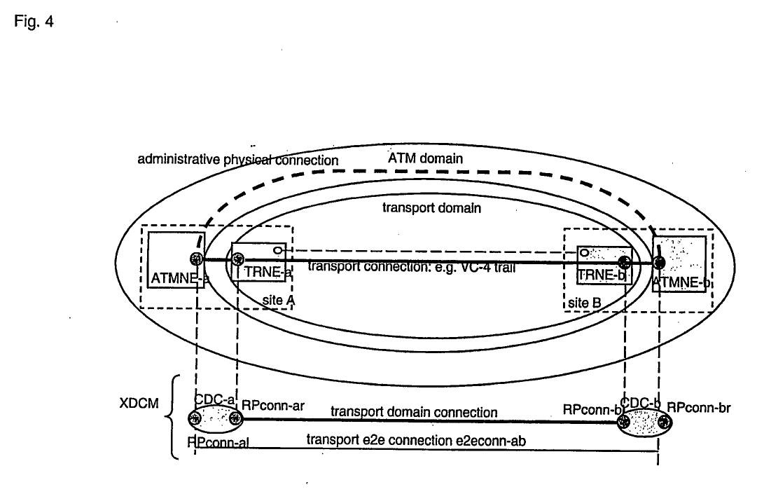

In a network scenario “Telephony and Internet Access via SDSL Technology”, an ATM based access network, telephone switching systems of the fixed line network and the network of an Internet Service Provider (ISP) are to be modeled (see FIG. 2-4). Further, the network transitions between the access network, to which the users are connected via SDSL technology, and the telephone switching systems provided for telephony services, as well as the access routers of the Intnet services access network are to be modeled. The SDSL connection point of the user in the DSLAM and the connection point in a telephone switching system—that is the two end points—and also the service profile, for example, ISDN standard, are required to set up a telephony service. For the data service, on the user side, the SDSL connection point should also be known, and on the network side, the access point to the Intnet services access network, and, likewise, the service profile, which, for example, contains the band width, should be known.

The general case, from which more exact rules can be derived for each network scenario, is described in the following. The two end points of a service are referred to as A

Selection of a free line (Resource Points), which, on the A side, provides the access into the entire network: as the network accesses are modeled, all free ports can be shown, so that a special one can be selected, for example, automatically per algorithm or manually by the operator.

Selection of a free line on the B side, analogous to the A side: depending on the network scenario, there may or may not be a dependence on a selected port on the A side. Dependencies arise through the network topology, which is, however, modeled in the database, so that they can be allowed for in the selection process. In the example of a telephony service via SDSL, a user who is connected to a certain SDSL port of a DSLAM in the access network, can only be routed to those telephone switching exchanges that are accessible to the DSLAM.

From outside, for example, from a “Service Provisioning System”, the request is formulated for the provision of an end-to-end service—in the data model: connectivity or end-to-end connection—between the two previously selected end points and with a certain service profile. Based on this information, combined with the information contained in the database, the following further steps must be carried out to provide the service.

The end-to-end service requires either that connectivity is provided or an end-to-end connection. Where a connectivity is provided, one must check whether this connectivity requires one or more end-to-end connections in the given network scenario. If not, then it is just the connectivity object that has to be generated in the database. Otherwise, one must determine the two end points for the end-to-end connection(s) and carry out the following steps, likewise for an end-to-end connection directly requested.

The path of the end-to-end connection through the network must be established. This is based on the knowledge of the network topology, in particular, of the network transitions, as well as on the knowledge of the free network resources at the access points of the individual domains.

The objects that model the end-to-end connection, i.e. cross domain connections and domain connections, are to be set up in the database (in the status “PLANNED”).

Tasks are to be established on the network management systems of the domains, which implement the necessary domain connections.

When all domain connections have been set up successfully, the status of the end-to-end connection can be set to “ACTIVE”.

All network resources required to provide a cross-technology end-to-end service are modeled and administered generically. The rules for providing services can be formulated on the basis of the service oriented data model. Using the data model, all the required network resources can be determined and the configuration in the network controlled. For each supported service, the rules determine the individual steps that are to be carried out in order to provide this service, and do so subject to the network topology. The configuration in the Sub-Networks can be done by generating commands to the network management system, or be fully automated, in as far as the interfaces are supported.

All in all, the advantages named below ensue.

An application for providing end-to-end services, which is implemented on the basis of the suggested data model and p re-set service provision rules, offers very flexible possibilities for extension. The support of new services always follows the same pattern, which means operator training is reduced.

In addition, such an application is predestined for the application of a commercial workflow management system, which reduces the development costs substantially. The rules for service provision can, for example, be directly converted into a process model of the workflow management system.

A service view is detached from the network view, thus enabling the services to be provided more quickly.

The provision of a service can be automated end-to-end, as all network transitions are known. Manual synchronization of the network transitions is no longer necessary.

This results in cost savings for network operators, as, on the one hand, less time is required to provide the services, and on the other, as the error frequency is reduced because the synchronization of the network transitions is automated. In the example of the SDSL-based telephony and data services, automation can reduce the provision time from several hours or days to as little as one minute.

The previously described process for providing services in a communication system is implemented by a computer program, which can b e loaded into a main memory of a data processing system and has code segments, on whose execution the steps described previously are carried out, when the computer program is executed in the data processing system.

This invention is not limited to the embodiment described herein.

1-4. (canceled)

5. A method for providing services in a communications system having sub-networks, comprising:
globally saving configuration information that describes network element functions for the sub-networks to a network element database; and
configuring the network elements by a network operating system,
accesses information that has been saved to a network element database when a service is established, modified and/or cancelled.

6. The method as claimed in claim 5, further comprising a first sub-network and a second sub-network, wherein the first and second sub-networks utilize different switching technologies.

7. The method according to claim 6, wherein the configuration information is read from individual sub-network databases and converted to a data model for the network element database.

8. A communication system, comprising:
a first sub-network and a second sub-network, the first and second sub-networks using different switching technologies and operating within the communication system;
a network element database having configuration information that describes network element functions, the network element database saved globally for the first and second sub-networks; and
a network operating system adapted such that when a service is established, modified and/or cancelled, the network elements are configured by accessing information that has been saved to the network element database.

9. A computer program loadable into a main memory of a data processing system, comprising at least one code segment that, upon execution, configuration information that describes network element functions is saved globally for a plurality of sub-networks within the data processing system in a network element database, and wherein when a service is established, modified and/or cancelled, the network elements are configured by a network operating system that accesses information saved to the network element database when the computer program is executed in the data processing system.
